(19) United States
(12) Patent Application Publication
(10) Pub. No.: US 2023/0099698 A1
(43) Pub. Date: Mar. 30, 2023

(54) Augmented Phase Chiller System for Component and Compartment Chilling

(71) Applicant: United States of America as represented by the Secretary of the Army, Washington, DC (US)

(72) Inventors: William P. Nikonchuk, Huntsville, AL (US); Geoffrey P. Suiter, Huntsville, AL (US)

(73) Assignee: United States of America as represented by the Secretary of the Army, Washington, DC (US)

(21) Appl. No.: 17/948,309

(22) Filed: Sep. 20, 2022

Related U.S. Application Data
(60) Provisional application No. 63/250,748, filed on Sep. 30, 2021.

(51) Int. Cl. F25B 21/04

(52) U.S. Cl. CPC F25B 21/04

(57) ABSTRACT

The chilling system provides cooling to components housed within a container by pumping propylene-glycol-water-mixture (PGWM) or equivalent through heat exchange assemblies and thermal transfer vessels. The thermal transfer vessels are filled with a paraffin-based phase change material (PCM) or equivalent solution for realizing phase change of the PCMs at selected melting points. The heat exchange assemblies are provided with thermal electric coolers for cooling the PGWM as it travels through the heat exchangers. The cooled PGWM is directed into and through a target cooling manifold of a target heat exchanger assembly to realize cooling the housed components. The system operates on direct current at under 500 watts of power and requires no Freon-type refrigerants or compressors. A microcontroller controls switches for realizing desired flow paths of the PGWM upon receiving phase change and temperature information from sensors.

### CROSS REFERENCE

Priority is claimed to Provisional Application No. 63/250,748 filed on Sep. 30, 2021, which is hereby incorporated by reference.

### GOVERNMENT RIGHTS

All rights in the Invention have been assigned to the U.S. Government.

### BACKGROUND OF THE INVENTION

### 1. Field of Invention

The present invention pertains to cooling systems. More particularly, the present invention pertains to a closed-loop, low-power cooling system that realizes phase change and energy storage capabilities for cooling and stabilizing the day and night-time temperatures of a targeted enclosure without need of Freon or Freon-type refrigerant.

### 2. Discussion of the Background

Many components and devices are subject to degradation and rendered unusable as a result of exposure to high ambient temperatures during operation or while stored. Typical cooling systems require expensive components, have high concomitant energy costs, and use environmentally unfriendly refrigerants.

### SUMMARY OF THE INVENTION

The present invention is a chilling system that includes a pump. A first heat exchanger assembly is provided with a first thermal electric cooler having a cool side and a hot side. The cool side of the first thermal electric cooler directly connects to a first cooling manifold. The first cooling manifold receives a propylene-glycol-water mixture from the pump, with the hot side of the first thermal electric cooler connecting to a first-heat-exchanger heat sink that connects to a first heat sink fan for directing heat away from the system.

A first thermal transfer vessel is filled with a first paraffin-based phase change mixture (PCM) and is fluidly connected to the first cooling manifold. The first paraffin-based phase change mixture has a first designated melting point temperature (first designated set point), with the first thermal transfer vessel having first-transfer-vessel tubing through which the propylene-glycol-water mixture enters and exits the first thermal transfer vessel.

A second thermal transfer vessel is filled with a second paraffin-based phase change mixture having a second predetermined melting point temperature (set point). The second thermal transfer vessel is fluidly connected in series to the first cooling manifold and to the first thermal transfer vessel. The second thermal transfer vessel has second-transfer-vessel tubing through which the propylene-glycol-water-mixture enters and exits the second thermal transfer vessel.

A second heat exchanger assembly has a second thermal electric cooler having a thermally cool side and thermally hot side, with the thermally cool side of the second thermal electric cooler directly connecting to a second cooling manifold. The pump is fluidly connected to the second cooling manifold and supplies the second cooling manifold with the propylene-glycol-water-mixture along a flow path that is separate from a flow path that supplies the first cooling manifold with the propylene-glycol-water-mixture. The thermally hot side of the second-heat-exchanger electric cooler connects to a second-heat-exchanger heat sink that connects to a second heat sink fan for directing heat away from the system.

A third thermal transfer vessel is filled with a third paraffin-based phase change mixture having a third designated melting point temperature (set point). The third transfer vessel is connected to the second cooling manifold and has third-transfer-vessel tubing through which the propylene-glycol-water-mixture enters and exits the third thermal transfer vessel.

A fourth thermal transfer vessel is fluidly connected in series to the second cooling manifold and to the third thermal transfer vessel. The fourth thermal transfer vessel is filled with a fourth paraffin-based phase change mixture having a fourth-designated melting point temperature (set point). The fourth thermal transfer vessel has fourth-transfer-vessel tubing through which the propylene-glycol-water-mixture enters and exits the fourth thermal transfer vessel. The fourth thermal transfer vessel is fluidly connected in series with the second cooling manifold and the third transfer vessel. The second cooling manifold, the third thermal transfer vessel and the fourth thermal transfer vessel are in parallel with the first cooling manifold, the first thermal transfer vessel and the second transfer vessel.

A target heat exchanger assembly is fluidly connected to the first thermal transfer vessel, to the second thermal transfer vessel, to the third thermal transfer vessel and to the fourth thermal transfer vessel. The target heat exchanger assembly has a target-cooling manifold through which the propylene-glycol-water-mixture flows and then returns to the pump. The target heat exchanger assembly further includes a target heat sink connected to the target-cooling manifold, with the target heat sink connecting to a target fan for directing cooled air to a target container.

A first solid-liquid sensor is located within the first thermal transfer vessel and a second solid-liquid sensor is located within the second thermal transfer vessel. A third solid-liquid sensor is located within the third thermal transfer vessel and a fourth solid-liquid sensor is located within the second thermal transfer vessel.

A microcontroller having an internal clock is electrically connected to the pump and to temperature sensors, with a first temperature sensor being located within the target cooling manifold. A second temperature sensor can be located within the targeted container and a third temperature sensor can be located outside of the targeted container to gauge outside air temperatures.

The microcontroller is electrically connected to the first solid-to-liquid sensor, to the second solid-to-liquid sensor, to the third solid-to-liquid sensor, and to the fourth solid-to-liquid sensor. The respective solid-liquid sensors send signals to the microcontroller upon detection of a phase change from solid to liquid or from liquid to solid of the respective paraffin-based phase change materials (PCMs). The microcontroller is connected to power supply sources for selectively imparting current to the first heat exchanger fan, the second heat exchanger fan, the target exchanger fan, and to the first and second thermal electric coolers.

Flow paths through which the a propylene-glycol-water mixture flows connect the pump and a fluid reservoir to the first and second cooling manifolds, to the first, second, third and fourth thermal transfer vessels and to the target cooling manifold. Upon receiving signals from the temperatures sensors and from the solid/liquid sensors located in the respective thermal transfer vessels, the microcontroller selectively activates switches positioned in the flow paths to realize a desired path for the propylene-glycol-water-mixture and activates the pump as required for detected day and night time conditions.

### DESCRIPTION OF THE DRAWINGS

A more complete appreciation of the invention and many of the attendant advantages thereof will be readily obtained by reference to the following detailed description when considered in connection with the accompanying drawings.

FIG. 1 is prior art schematic of a Freon-based cooling system.

FIG. 2 is a simplified schematic of the Augmented Phase Chiller system of the present invention.

FIG. 3 is a side view of heat exchanger assembly in accordance with the present invention.

FIG. 4 is a perspective, exploded view of the heat exchanger assembly in accordance with the present invention.

FIG. 5 is a side view of a thermal electric cooler (TEC) in accordance with the present invention.

FIG. 6 is a side-view of the target manifold heat exchanger (TM-HEX) assembly in accordance with the present invention.

FIG. 7 is a schematic of a toggle-actuated throttle switch for directing fluid flow in accordance with the present invention.

FIG. 8 is an x-ray top view of a fluid manifold containing a Propylene-Glycol-Water-Mixture (PGWM) in accordance with the present invention.

FIG. 9 is an x-ray side view of a thermal transfer vessel in accordance with the present invention.

FIG. 10 is a schematic of an integrated pump assembly in accordance with the present invention.

FIG. 11 is a schematic of the Augmented Phase Chiller system of the present invention.

FIG. 12 is schematic of the electrical connections of the microcontroller and power sources in accordance with the present invention.

FIG. 13 is a flow chart depicting flow paths directed by the logic functions of the microcontroller used in the present invention.

FIG. 14 is a schematic of the main or target heat exchange assembly of the present invention as it connects to the interior of the target container.

FIG. 15 is a schematic of the main or target heat exchange assembly in accordance with the present invention as used to cool a small control room.

### DETAILED DESCRIPTION

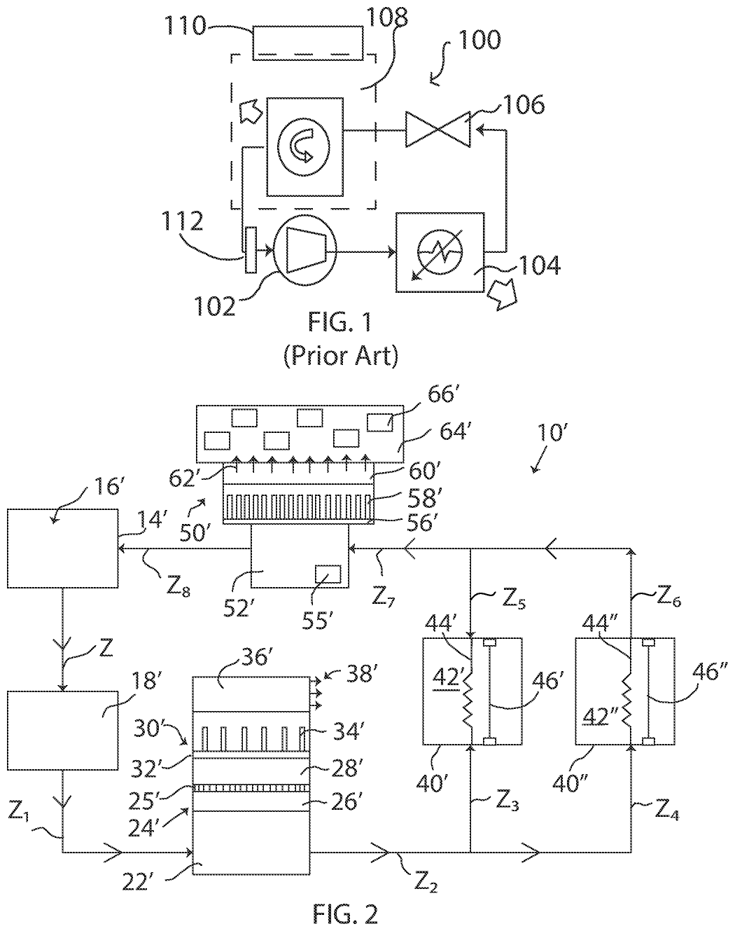

In FIG. 1, a typical prior-art cooling system 100 is provided with a compressor 102, condenser 104, expansion valve 106, evaporator 108, and accumulator 112. Freon is used as the phase change mechanism, with phase changes being implemented by the compressor 102 and evaporator 108. The cooling system 100 operates on 120 volts AC and expends 2-3 kilowatts of power in cooling a target 110 at temperatures ranging from 10 to 65 degrees F.

In FIG. 2, the Augmented Phase Chiller system 10′ of the present invention has a reservoir 14′ containing a Propylene-Glycol-Water-Mixture (PGWM) 16′. Reservoir 14′ is connected to pump 18′ via a flow path Z. Pump 18′ connects to heat exchanger assembly (HEX) 20′. Heat exchanger assembly 20′ has a PGWM cooling manifold 22′ that receives PGWM via flow path Z₁, with PGWM being distributed throughout manifold 22′ prior to exiting via outflow path Z₂. Manifold 22′ is connected to the cool side 26′ of thermal electronic cooler (TEC) 24′. The hot side 28′ of the thermal electric cooler 24′ is connected to heat sink 30′ that connects to fan 36′ that operates for purposes of removing heat, represented by arrows 38, from the system.

Output flow path Z₂ branches into flow paths Z₃ and Z₄ (FIG. 2). Flow path Z₃ connects to thermal transfer vessel 40′. Thermal transfer vessel 40′ contains a phase change material (PCM) 42′ for storing thermal energy. The phase change material 42′ is a paraffin-based solution having a designated melting point (or set point). Flow path Z₄ connects to thermal transfer vessel 40″, with vessel 40″ containing a paraffin-based phase change material 42″ having its own designated melting point (or set point).

Vessels 40′ and 40″ have respective solid-to-liquid sensors 46′ and 46″. Vessel 40′ has copper tubing 44′ that connects input flow path Z₃ to output flow path Z₅ and vessel 40″ has copper tubing 44″ that connects input flow path Z₄ to output flow path Z₆.

Still with reference to FIG. 2, flow paths Z₅ and Z₆ flow into flow path Z₇, with flow path Z₇ providing cooled PGWM to manifold 52′. Manifold 52′ connects to heat sink 54′ having thermal distributing fins 58′, with heat sink 54′ connecting to fan 60′ that blows cool air 62′ into container 64′ containing stored components 66′. Flow path Z₅ is an outlet flow path from manifold 52′ and returns the PGWM to reservoir 14′.

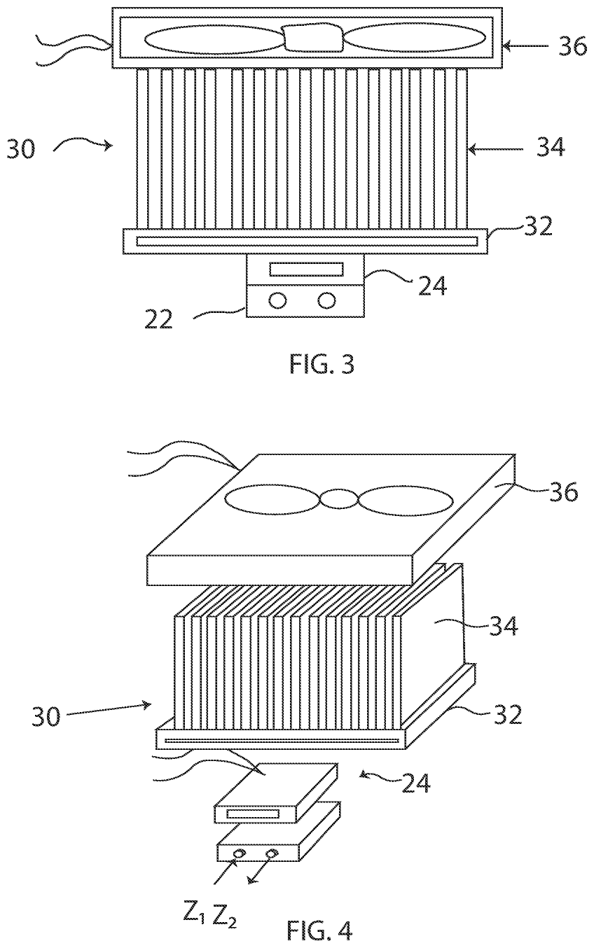

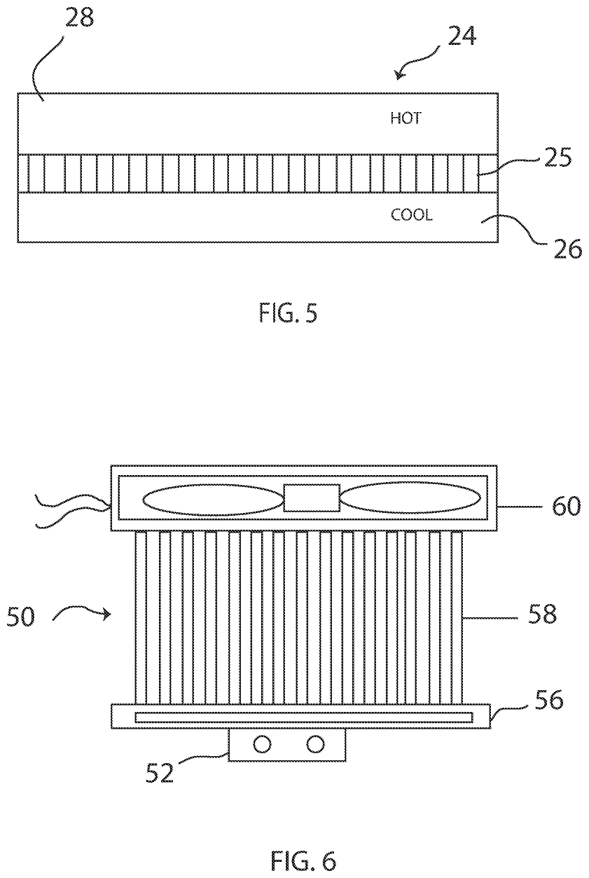

In FIGS. 3 and 4, a heat exchanger assembly (HEX) 20′ includes heat sink 30 having a base 32 to which heating dispersing fins 34 are attached. The base 32 is attached to the hot side 28 (FIG. 5) of a thermal electric cooler (TEC) 24, with the cool side 26 of thermal electric cooler 24 being attached to manifold 22 having a PGWM inlet Z₁ and a PGWM outlet Z₂.

In FIG. 5, a thermal electric cooler 24 has a hot side 28 and a cool side 26. Sandwiched between the hot side 28 and cool side 26 is a middle region 25 of P-N semiconductor material that when subjected to a direct current, in accordance with the Peltier effect, imparts cooling to the cool side 26 and heat to the hot side 24 of TEC 24. The TEC used in the prototype of the present invention was a commercially available TEC of type 12706 or 12710 or 12720.

In FIG. 6, a target manifold heat exchanger assembly (M-HEX) 50 has a heat sink 54 that includes a heat sink base 56 that connects to thermal transfer fins 58. Fan 60 is mounted on the heat sink 54, with the bottom of heat sink base 56 connecting to target manifold 52.

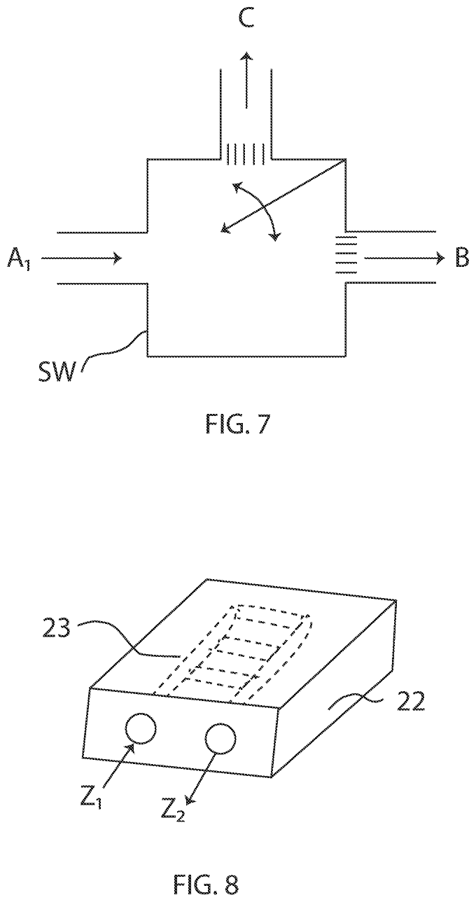

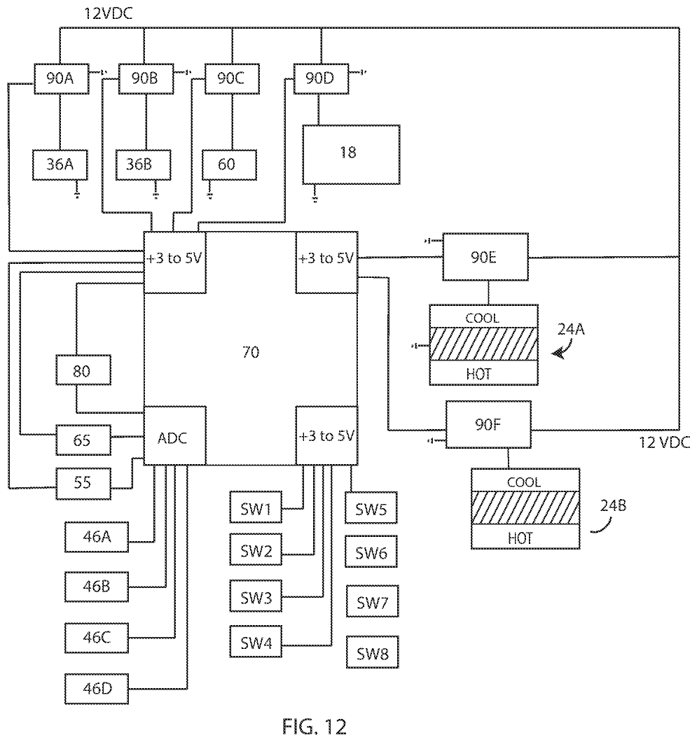

In FIG. 7, a fluid toggle switch SW as used in the present invention has an inlet A₁ and outlets B and C. Switch SW is able to alternatively open or close outlets B and C. The open and close function of the switch is activated via microcontroller 70 (FIG. 12) that is programmed to achieve the desired system functions. In a prototype of the invention, switch SW was a commercially available switch having a two-way motorized ball valve and consuming a power level of 12 Volts DC controlled by a FET or Relay with a 3-5V gate signal or a similar servo or stepper motor system operating at 5 Volts DC.

In FIG. 8, PGWM manifold 22 has distribution piping 23 for distributing PGWM throughout the manifold, PGWM entering through inlet Z₁ and exiting through outlet Z₂.

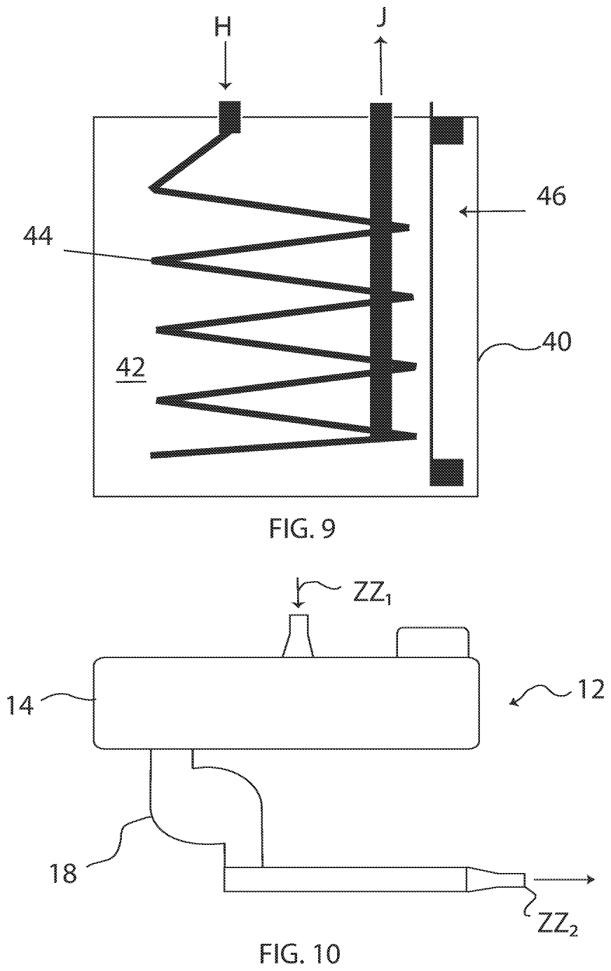

With reference to FIG. 9, a thermal transfer vessel 40 in accordance with the present invention is filled with a paraffin-based Phase Change Material (PCM). Piping 44 that was made of copper in the prototype of the present invention received PGWM through inlet H, with PGWM traveling through piping 44 and exiting through outlet J. A Solid/Liquid Sensor (SLS) 46 provides input to the microcontroller 70 for performance of the switching functions (SW 1 to SW 8) in accordance with the logic functions programmed into the microcontroller.

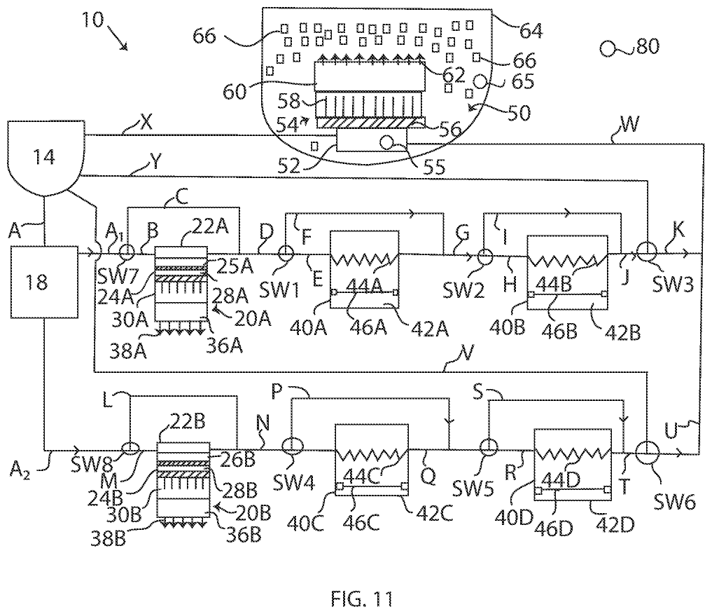

With reference to FIG. 10, an integrated pump and PGWM reservoir 14 as used in the prototype system of FIG. 11 has a PGWM reservoir (having a capacity of 1 Quart to 1 Gal) that receives returned PGWM through inlet ZZ₁. The PGWM stored in reservoir 14 is pumped through pump 18 and output through outlet ZZ₂. For the prototype system of FIG. 11, the pump 18 was a commercial grade liquid pump capable of propelling the PGWM at 2 Gallons per minute (GPM) (+/−1 GPM). However, pumping requirements and capacity are to be tailored to the needs of a given system.

With reference to FIG. 11, the Augmented Phase Chiller System of the present invention has a reservoir 14 for holding and storing a Propylene-Glycol-Water-Mixture (PGWM) 16. Flow path A from reservoir 14 connects to pump 18. Pump 18 has outlets represented by flow paths A₁ and A₂. Flow path A₁ connects to toggle-actuated fluid switch SW7. Switch SW7 allows flow path A₁ to connect to flow path B or to flow path C. Flow path B flows into manifold 22A of heat exchanger assembly 20A with the output of manifold 22A connecting to flow path D. Alternatively, switch SW7 can be actuated to allow flow path A₁ to connect to flow path C. Flow path C bypasses the heat exchanger assembly 20A and connects to flow path D.

Flow path D (FIG. 11) connects to toggle-actuated fluid switch SW1. Switch SW1 allows flow path D to connect to flow path E or to flow path F. Flow path E inputs to thermal transfer vessel 40A, with the output of thermal transfer vessel 40A connecting to flow path G. Alternatively, switch SW1 can be actuated to allow flow path D to connect to flow path F. Flow path F bypasses thermal transfer vessel 40A and connects to flow path G.

Flow path G (FIG. 11) connects to toggle-actuated fluid switch SW2. Switch SW2 allows flow path G to connect to flow path H or to flow path I. Flow path H inputs to thermal transfer vessel 40B, with the output of thermal transfer vessel 40B connecting to flow path J. Alternatively, switch SW2 can be actuated to allow flow path G to connect to flow path I. Flow path I bypasses thermal transfer vessel 40B and connects to flow path J.

Flow path J (FIG. 11) connects to toggle-actuated fluid switch SW3. Switch SW3 allows flow path J to connect to flow path K or to flow path Y. Flow path K connects to flow path W, with flow path W connecting to cooling manifold 52 of main or target heat exchanger 50. Alternatively, switch SW3 can be actuated to allow flow path J to connect to flow path Y. Flow path Y is a return flow path to reservoir 14.

Flow path A₂ (FIG. 11) connects the output of pump 18 to toggle-actuated fluid switch SW8. Switch SW8 allows flow path A₂ to connect to flow path M or to flow path L. Flow path M flows into manifold 22B of heat exchanger assembly 20B, with the output of manifold 22B connecting to flow path N. Alternatively, switch SW8 can be actuated to allow flow path A₂ to connect to flow path L. Flow path L bypasses the heat exchanger assembly 20B and connects to flow path N.

Flow path N (FIG. 11) connects to toggle-actuated fluid switch SW4. Switch SW4 allows flow path N to connect to flow path O or to flow path P. Flow path O inputs to thermal transfer vessel 40C, with the output of thermal transfer vessel 40C connecting to flow path Q. Alternatively, switch SW4 can be actuated to allow flow path O to connect to flow path P. Flow path P bypasses thermal transfer vessel 40A and connects to flow path Q.

Flow path Q (FIG. 11) connects to toggle-actuated fluid switch SW5. Switch SW5 allows flow path Q to connect to flow path R or to flow path S. Flow path R inputs to thermal transfer vessel 40D, with the output of thermal transfer vessel 40D connecting to flow path T. Alternatively, switch SW5 can be actuated to allow flow path Q to connect to flow path S. Flow path S bypasses thermal transfer vessel 40D and connects to flow path T.

Flow path T (FIG. 11) connects to toggle-actuated fluid switch SW6. Switch SW6 allows flow path T to connect to flow path U or to flow path V. Flow path U connects to flow path W, with flow path W connecting to cooling manifold 52 of main or target heat exchanger 50. Alternatively, switch SW6 can be actuated to allow flow path T to connect to flow path V. Flow path V is a return flow path to reservoir 14. Flow path U connects to flow path W, with flow path W connecting to cooling manifold 52 of main or target heat exchanger 50. Flow path X connects the output of cooling manifold 52 to reservoir 14.

Still with reference to FIG. 11, heat exchanger assembly 20A includes a thermal electric cooler 24A. When switch SW7 is activated to allow PGWM fluid to flow from flow path B into manifold 22A, the cooling side 26A of thermal electric cooler 24A cools the PGWM fluid in manifold 22A. The hot side 28A of thermal electric cooler 24A connects to heat sink 30A, with the heat sink 30A connecting to fan 36A which directs the heat (indicated by arrows 38A) away from the system.

Heat exchanger assembly 20B includes a thermal electric cooler 24B. When switch SW8 is activated to allow PGWM fluid to flow from flow path M into manifold 22B, the cooling side 26B of thermal electric cooler 24B cools the PGWM fluid in manifold 22B. The hot side 28B of thermal electric cooler 24B connects to heat sink 30B, with the heat sink 30B connecting to fan 36B which directs the heat (indicated by arrows 38B) away from the system.

When switch SW1 is activated to allow PGWM fluid to flow through flow path E, PGWM fluid flows through the piping 44A of thermal transfer vessel 40A to output flow path G. In the prototype of the present invention thermal transfer vessel 40A was filled with a paraffin-based phase change material 42A having a set point of 68° F. (+/−10° F.). Thermal vessel transfer 40A is internally equipped with solid-to-liquid sensor 46A that is electrically connected to microcontroller 70 (FIG. 12).

When switch SW2 is activated to allow PGWM fluid to flow through input flow path H, PGWM fluid flows through the piping 44B of thermal transfer vessel 40B to output flow path J. In the prototype of the present invention thermal transfer vessel 40B was filled with a paraffin-based phase change material 42B having a set point of 86° F. (+/−10° F.). Thermal vessel transfer 40B is internally equipped with solid-to-liquid sensor 46B that is electrically connected to microcontroller 70 (FIG. 12).

Still with reference to FIG. 11, when switch SW4 is activated to allow PGWM fluid to flow through input flow path O, PGWM fluid flows through the piping 44C of thermal transfer vessel 40C to output-flow path Q. In the prototype of the present invention, thermal transfer vessel 40C was filled with a paraffin-based phase change material 42C having a set point of 68° F. (+/−10° F.) Thermal vessel transfer 40C is internally equipped with solid-to-liquid sensor 46C that is electrically connected to microcontroller 70 (FIG. 12).

When switch SW5 is activated to allow PGWM fluid to flow through input flow path R, PGWM fluid flows through the piping 44D of thermal transfer vessel 40D to output-flow path T. 86° F. (+/−10° F.) Thermal vessel transfer 40D is internally equipped with solid-to-liquid sensor 46D that is electrically connected to microcontroller 70 (FIG. 12).

The main or target heat exchanger 50 (FIG. 11) includes a cooled manifold 52 that is connected to a heat sink 54 having a heat-sink base 56 onto which are mounted cooling fins 58. The fan 60 of heat exchanger 50 directs cooled air (indicated by arrows 62) to the inside of container 64 that contains targeted components 66. In the prototype of the present invention, the target container 64 had dimensions of 3 ft by 3 ft by 1.5 ft (13.5 cubic feet).

In FIG. 12, a microcontroller 70, which in the prototype of the present invention was a Arduino™ board, controls and is electrically connected to fans 36A, 36B and 60; to switches SW1, SW2, SW3, SW4, SW5, SW6, SW7 and SW8; to thermal electric coolers 24A and 24B; to solid-to-liquid sensors 46A, 46B, 46C and 46D; and to pump 18. Fan 36A is connected to relay 90A, fan 36B is connected to relay 90B, and fan 60 is connected to relay 90C. Pump 18 is connected to relay 90D.

Relay 90E is connected to thermal electric cooler 24A, and relay 90F is connected to thermal electric cooler 24B. An analog to digital converter ADC is connected to microcontroller 70 which is connected to temperature sensor 55 located within target cooling manifold 52, to temperature sensor 65 in the target container 64 and to a temperature sensor 80 which is positioned outside the system to gauge ambient air surrounding the container 64.

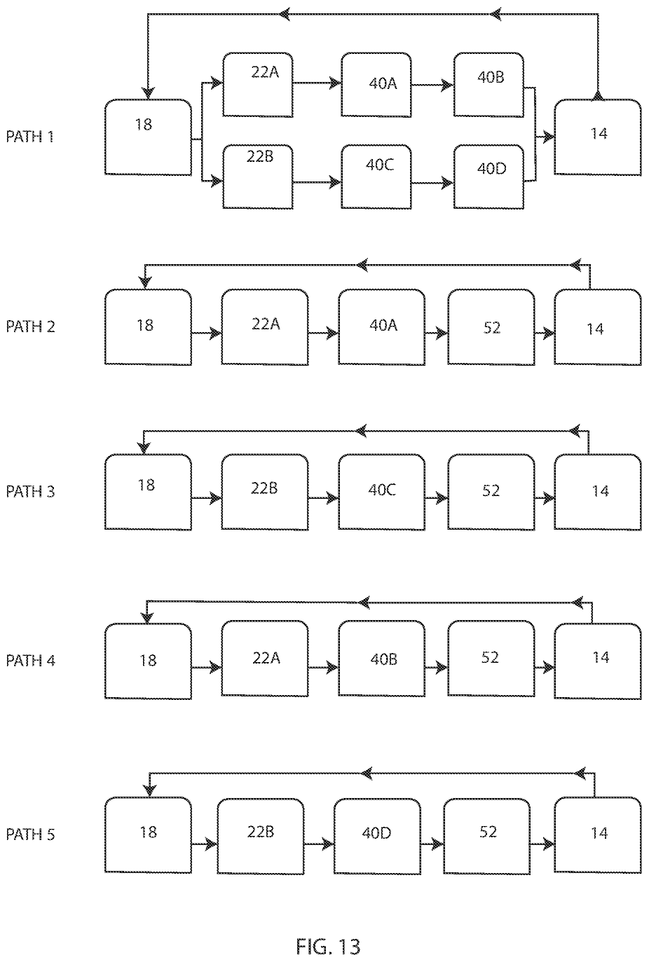

The microcontroller 70 used in the present invention can be programmed to realize optimal cooling and energy-saving results for a given environment. FIG. 13 provides an example of the programming possibilities for the protype system 10 of FIG. 11.

The microcontroller 70 (FIG. 11) uses a clock source and receives feedback from temperature sensors 55, 65 and 80 and solid/liquid sensors 46A, 46B, 46C and 46D. The clock source can be used for selecting the optimal times for utilizing the respective Phase Change Materials 42A, 42B, 42C, 42D housed in the respective thermal transfer vessels 40A, 40B, 40C, 40D. The outside air temperature (OAT) is the best source of information as concerns whether the liquified PCMs can be reconstituted to the sold phase or whether it would be more efficient to connect the thermal electric coolers 24A, 24B directly with the target manifold 52. When the thermal electric coolers are connected directly to the target manifold, this is an emergency high-power mode with more power being provided to the thermal electric coolers to allow for more efficient cooling.

For the weather environment the system 10 finds itself, the initial conditions and parameters are preset by the microcontroller 70 for an initial-condition time, e.g., 0300 hours (3 am). At that time, the OAT can be used to make the determination if the PCMs can be reconstituted and if so TECs 24A and 24B will be activated with the PGWM fluid directed through Path 1 (FIG. 13).

When conditions are such that PGWM fluid can be directed to the main target manifold 52, the temperature T1 inside target manifold 52, as detected by temperature sensor 55, will be used to verify that the cooling cycle is efficient and optimal, or whether there is fouling in piping 44A, 44B, 44C and 44D of thermal transfer vessels 40A, 40B, 40C, 40D or in the manifolds 22A or 22B of thermal electric coolers 24A and 24B.

When the solid liquid sensors 46A, 46B, 46C, 46D all sense that the respective phase change material 42A, 42B, 42C, 42D is a solid, then each respective sensor sends a “solid” signal to the microcontroller 70 where it is converted to the binary logic value of “0” (zero) indicating the phase change material in each of the thermal transfer vessels 40A, 40B, 40C, 40D is a solid. When the phase material in all of the thermal transfer vessels is solid and the outside air temperature OAT detected by thermal sensor 80 is less than the temperature T1 inside the target manifold 52 as detected by temperature sensor 55, the pump 18 is turned off.

When the solid liquid sensors 46A, 46B, 46C, 46D all sense that the respective phase change material 42A, 42B, 42C, 42D is a liquid, then each respective sensor sends a “liquid” signal to the microcontroller 70 where it is converted to the binary logic value of “1” (one), indicating the phase change material in each of the thermal transfer vessels is liquid.

When the phase material in all of the thermal transfer vessels is liquid, the pump 18 is on and the microcontroller sends signals to the respective switches to realize Path 1 (FIG. 13). In Path 1, the propylene glycol water mixture (PGWM) is simultaneously directed to manifolds 22A and 22B. From manifold 22A, the PGWM travels to thermal transfer vessel 40A, to thermal transfer vessel 40B, to reservoir 14, and back to pump 18. From manifold 22B, the PCWM travels to thermal transfer vessel 40C, to thermal transfer vessel 40D, to reservoir 14, and back to pump 18.

In Path 1, the PCM which travels through manifold 22A, through thermal transfer vessel 40A and through thermal transfer vessel 40B can be viewed as taking a first parallel path, with the PCWM which travels through manifold 22B, through thermal transfer vessel 40C and through thermal transfer vessel 40D as taking a second parallel path.

Pump 18 will be on at any time when at least one of the solid/liquid sensors indicates that the phase change material PCM in any one of the thermal transfer vessels is in a liquid phase. The solid/liquid sensors used in the present invention are commercially available and detect when the PCM turns to a liquid phase by measuring the intensity of LED light which becomes more intense as the PCM melts and becomes more translucent. When the PCM in all of the thermal transfer vessels 42A, 42B, 42C, 42D is in the liquid phase, this means that the temperature of the PCWM has reached or exceeded the setpoint of the phase change material in each one of the thermal transfer vessels.

Since in the prototype example of FIG. 11, the set point of the PCM in thermal transfer vessels 42B and 42D is 86 degrees F. and the set point of PCM in thermal transfer vessels 40A and 40C is 68 degrees F., for the PCM in all of the thermal transfer vessels to be in the liquid phase, the temperature of the PCWM circulating through the system would need to be at a temperature of at least 86 degrees F. for an extended length of time.

When PCWM has reached a temperature where all the PCM in all the thermal transfer vessels is in a liquid phase, the PCWM must be cooled to thereby cool the phase change material PCM in the respective transfer vessels. To accomplish this, the system is switched to the flow path of Path 1 (FIG. 13).

The greatest cooling requirements are those necessitated as a result of the heating effects from the sunshine of the daylight hours, roughly between 0800 and 2000 hours (8 am to 8 pm.) That time period can be understood as a daylight or high temperature period where the outside air temperature OAT is elevated. The night-time or lower temperature period can be understood as the period from 2000 to 0800 hours. If a liquid phase is detected in any of the thermal transfer vessels during the night-time temperature period, the pump is turned on and Path 1 is established.

Thus, at 0800, the PCM 42A in thermal transfer vessel 40A is solid as would be the PCM in all of the thermal transfer vessels. To make use of the thermal energy stored in thermal transfer vessel 40A, at 0800 hours, the microcontroller 70 commands the requisite switching to establish PGWM flow through Path 2. In Path 2 the PGWM from pump 18 circulates directly to manifold 22A, then to thermal transfer vessel 40A, to target manifold 52, to reservoir 14 and back to pump 18 with the circulation continuing.

When the thermal sensor 46A in thermal transfer vessel 40A detects that the PCM 42A has changed to a liquid phase, the liquid-phase signal that is sent to microcontroller 70 results in the microcontroller implementing switching so as to establish PGWM flow through Path 3 (FIG. 13). In Path 3, the PGWM from pump 18 circulates directly to manifold 22B, then to thermal transfer vessel 40C, to target manifold 52, to reservoir 14 and back to pump 18 with the circulation continuing.

When thermal sensor 46C in thermal transfer vessel 40C detects that the PCM 42C therein has changed to a liquid phase, the liquid-phase signal that is sent to microcontroller 70 results in the microcontroller implementing switching so as to establish PGWM flow through Path 4.

As a result of the thermal transfer effects that occurred in Paths 2 and 3, the PCMs in thermal transfer vessels 40A and 40C have turned to liquid. As Path 4 is implemented, the PCMs 42B and 42D in thermal transfer vessels 40B and 40D remain in a solid phase in that the PCMs in vessels 40B and 40D have a higher set point than those in vessels 40A and 40C.

Upon the microcontroller 70 implementing switching signals to realize Path 4, the PGWM is sent from pump 18 to manifold 22A, to thermal transfer vessel 40B, to target manifold 52, to reservoir 14 and then returned to pump 18 where the circulation is repeated.

When the solid/liquid sensor 46B detects that the PCM in thermal transfer vessel 40B has become liquid, a signal is sent to the microcontroller 70 and switching functions are implemented to realize Path 5 (FIG. 13) so as to take advantage of the thermal properties of the PCM in thermal transfer vessel 40D that is still in a solid state.

In Path 5, the PGWM is sent from pump 18 to manifold 22B, to thermal transfer vessel 40D to target manifold 52, to reservoir 14 and then returned to pump 18 where the circulation is repeated. Once the PCM 42D turns to liquid, and with all of the PCMs now being in a liquid state, the system is returned to Path 1 until all the PCMs 42A, 42B, 42C, 42D become solid at which time Paths 2, 3, 4 and 5 are repeated while in the high temperature time period.

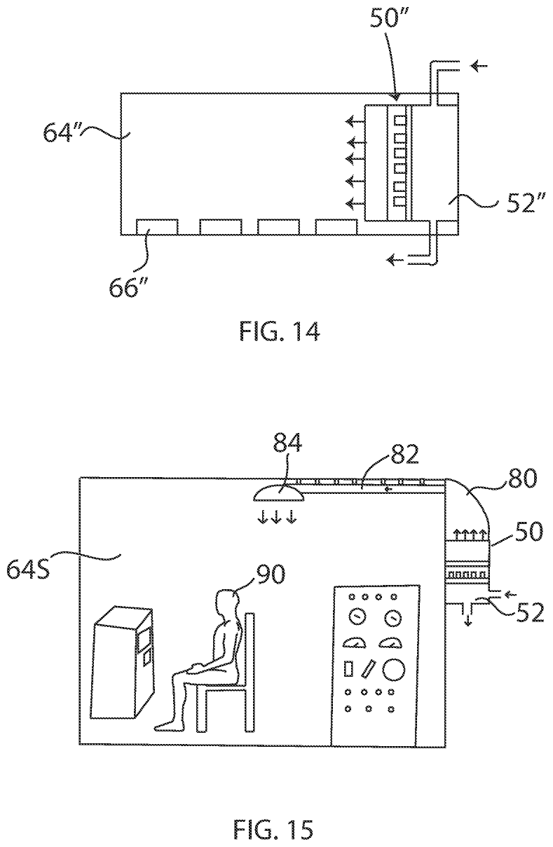

In FIG. 14, main or target heat exchanger 50″ cools the components 66″ stored within container 64″. The heat exchanger 50″ is fully within the container 64″ and recirculates the air within the container as opposed to cooling ambient air from outside the container. The system therefore can be used in a NEMA 4X or IP68 rated enclosure and maintain the rating with only coolant input and output passthroughs being added. This configuration is known as the split-unit configuration.

The heat exchanger 50″ needs to have a stand-off distance from the wall of the container in order to cool the plenum most effectively. Consideration must be taken to avoid creating a loop and stagnation points that would be at elevated temperatures.

Ducting can also be run for an air input and an output on the system being cooled, which is known as the air conditioner configuration. The ducting can also mate to existing connectors readily and an ad-hoc cooling and drying system can be added to existing systems where desiccants would otherwise be added.

In FIG. 15, the target main heater exchanger assembly 50 includes target manifold 52, as mounted on target cooled space 64S which could be, for example, a small control room measuring 8 ft by 8 ft by 8 ft (512 cubic ft). Outside ducting 80 connects to interior ducting 82 that connects to vent 84 to cool the small room and the person 90 in the room.

The present invention is a closed loop, non-Freon, non-vapor compression and low-powered chilling system that implements active phase change and energy storage. Thermal electric coolers (TEC) 24A, 24B (FIG. 11) are used in combination with thermal transfer vessels 40A, 40B, 40C, 40D that are filled with paraffin-based phase change material having different set or melting points.

As has been stated, in the prototype of the present invention, transfer vessel 40A contained phase change material 42A having a melting point of 68 degrees F.; transfer vessel 40B contained a phase change material having a melting point of 68 degrees F.; transfer vessel 40C contained a phase change material 42C having a melting point of 86 degrees F.; and transfer vessel 40D contained a phase change material 42D having a melting point of 86 degrees F. (FIG. 11)

The melting points of the PCMs in the respective transfer vessels are set at lower temperatures levels than the ambient temperatures encountered at various times of the day and night. The PCM used is a commercially available sustainable Bio-PCM, considered to be of renewable resources, which is paraffin based. Additives are added to increase or decrease the desired set points for implementation in the respective transfer vessels.

The Propylene-Glycol-Water-Mixture (PGWM) 16 remains in liquid form throughout the system 10 and serves as the thermal transfer mechanism as it travels through the respective flow paths, made possible by paths A, B, C, D, E, F, G, H, I J, K L, M, N, O, P, Q, R, S, T, U, V, W, X and Y (FIG. 11) and switches SW1, SW2, SW3, SW4, SWS, SW6, SW7, SW8.

From pump 18 the PGWM 16 can be pumped to heat exchangers 20A and 20B. Switches SW1, SW2, SW3, SW4, SW5, SW6, SW7, SW8 in being selectively switched and activated by microcontroller 70 can create multiple desired flow paths for traveling through or around the manifold 22A of heat exchanger 20A, and through thermal transfer vessels 40A and 40B and/or traveling through or around the manifold 22B of heat exchanger 20B, and through thermal transfer vessels 40C and 40D.

The thermal electric coolers 24A, 24B used in the prototype of the present invention were commercial grade of standard type 12706 or 12710 or 12720 for use with a 100 to 300 watt power source for purposes of producing a temperature differential from 20 to 55 degrees F. from the ambient air surrounding heat exchanger assemblies 20A and 20B.

The phase change materials 42A, 42B, 42C, 42D, in the thermal transfer vessels, e.g., in vessels 40A, 40B, 40C and 40D, in following the principle of latent heat or enthalpy of fusion, transform from a solid to liquid phase at lower temperature levels than the ambient air outside the transfer vessels, and without need of pressure changes.

Once the PGWM is at a specified temperature detected by a temperature sensor 55 in manifold 52, microcontroller 70 can activate pump 18 resulting in the PGWM being pumped out of the manifold 52 in into reservoir 14.

If temperature sensors and feedback from liquid/solid sensors indicate there is not a present need to direct cooling to the main manifold, the pump can be shut down via FET or relay and the system can go into a low power standby mode, with the respective fans remaining on.

It is also possible to isolate the PCM heat exchangers via valves being shut off to them and increase the efficiency even further. The cooling target heat exchanger can use an intake and exhaust thermal measuring device to determine the cooling needs and throttle them for higher efficiency if/as needed or as a secondary to that on the cooling system.

The cooling manifolds, 22A and 22B can also have temperature sensors in order to create a duty cycle to optimize the fluid temperature for applications which require an exact temperature, which would use a conductive heat exchanger instead of the air-cooling heat exchangers typically used.

As was stated, the microcontroller 70 used in the prototype of the present invention was an Arduino' circuit board (model UNO) having logic for controlling dwell time and temperature in the target manifold and heat exchangers. Various microcontrollers could be used with the invention for controlling the operation of the system.

Microcontroller 70 controls whether the TECs 24A, 24B and their respective fans 36A, 36B are on, the position of valves, i.e., switches connected to the heat exchangers and whether they are bypassed or active, whether the cooling fan 60 is on in the cooling target, and whether the pump 18 is running. Microcontroller 70 receives atmospheric data and receives the phase change status of the PCM in the respective thermal transfer vessels 40A, 40B, 40C and 40D, so that appropriate switching can be initiated to direct PGWM flow to the optimal paths.

In a prototype of the present invention (FIG. 11), heat exchanger assembly 20A, first thermal transfer vessel 40A and second thermal transfer vessel 40B are serially connected and are in parallel with the serially connected second heat exchanger assembly 20B, third thermal transfer vessel 40C and fourth thermal transfer vessel 40D. Additional parallel rows of serially connected heat exchanger assemblies and thermal transfer vessels can be added to accommodate situational climatic conditions. So too, the melting points of the respective phase change materials in the respective thermal transfer vessels can be selected based upon desired cooling effects and the situational climatic conditions. The phase change material (PCM) as used in the prototype of the present invention was a sustainable Bio-PCM, however the system can use eutectic based PCMs.

The thermal transfer vessels 40A, 40B, 40C and 40D of system 10 can be conceptualized as being analogous to the compressor/condenser stages of a Freon-based refrigerant system; however, in the present invention, there is no need for compression or pressurization to achieve phase change of the respective thermal-energy storing paraffin-based solutions.

The present invention is not for the purpose of achieving below freezing temperatures, but to reduce the temperatures experienced by components stored in a containment environment that would otherwise experience elevated temperatures as a result of ambient conditions. The present invention keeps stored components at temperatures that will greatly enhance shelf-life. This improved shelf life is sometimes expressed as improved Mean-Time-Between-Failures (MTBF) of the targeted components.

The present invention is particularly effective in reducing inside-container temperature to acceptable storage-level temperatures when outside temperatures are at their thermal peak and achieves that objective while requiring less than 500 watts of power to operate. The system 10 of FIG.11, for example, can operate on 12 or 28 volts DC and use between 4 and 42 amps while expending a mere 50 to 500 watts of power.

To cool larger volume containers, the operating voltage can be increased to satisfy power requirements, and the number of parallel heat exchanger assemblies can be increased as well as choosing lower set points for the respective phase change mixtures housed in the respective thermal transfer vessels.

Various modifications and embodiments of the invention may be made by those skilled in the art without departing from the scope and spirit of the foregoing disclosure. Accordingly, the scope of the invention is limited only by the following claims.

What is claimed is:

1. A chilling system, comprising:
a pump for pumping a propylene-glycol-water-mixture;
a heat exchanger assembly that has a thermal electric cooler having a cool side and a hot side, with the cool side of said thermal electric cooler directly connecting to a cooling manifold, said cooling manifold being positioned for receiving the propylene-glycol-water-mixture;
a first thermal transfer vessel positioned to receive the propylene-glycol-water-mixture from said cooling manifold, said thermal transfer vessel being filled with a paraffin-based phase change material having a first predetermined melting point;
a second thermal transfer vessel positioned to receive the propylene-glycol-water-mixture from said cooling manifold, said second thermal transfer vessel being filled with a second paraffin-based phase change material having a second predetermined melting point;
a target manifold positioned to receive the propylene-glycol-water-mixture;
a plurality of flow paths that can connect the pump, the first transfer vessel, the second transfer vessel and said target manifold;
a microcontroller; and
a plurality of switches located in the plurality of flow paths, with said plurality of switches being opened and closed in response to signals sent from said microcontroller to effectuate desired paths through which the propylene-glycol-water-mixture can travel.

2. A chilling system according to claim 1, further comprising:
a second heat exchanger assembly having a second thermal electric cooler, with said second thermal electric cooler having a cool side and a hot side, with the cool side of said second thermal electric cooler directly connecting to a second cooling manifold, said second cooling manifold being positioned for receiving the propylene-glycol-water-mixture from said pump;
a third thermal transfer vessel positioned to receive the propylene-glycol-water-mixture from said second cooling manifold, said third thermal transfer vessel being filled with a third paraffin-based phase change material having a third predetermined melting point;
a fourth thermal transfer vessel positioned to receive the propylene-glycol-water-mixture from said second cooling manifold, said fourth thermal transfer vessel being filled with a fourth paraffin-based phase change material having a fourth predetermined melting point; and wherein:
said plurality of flow paths includes flow paths connecting the pump, the third thermal transfer vessel, the fourth transfer vessel and the target manifold and said plurality of switches includes switches positioned in the flow paths connecting said pump, said third transfer vessel, said fourth transfer vessel and said target manifold.

3. A chilling system according to claim 2, wherein:
said cooling manifold, said first thermal transfer vessel and said second thermal transfer vessel are fluidly connected in series and in parallel to said second cooling manifold, said third thermal transfer vessel and said fourth transfer vessel.

4. A chilling system according to claim 1, further comprising:
a first solid/liquid sensor for detecting when the paraffin-based phase change material changes phase and a second solid/solid liquid sensor for detecting when said second phase change material changes phase, said first solid/liquid sensor and said second solid/liquid sensor being electrically connected to said microcontroller.

5. A chilling system according to claim 4, wherein:
said heat exchanger assembly further includes a heat sink connected to the hot side of the thermal electric cooler, said heat sink connecting to a fan for directing warm air away from the cooling manifold of the heat exchanger assembly.

6. A chilling system according to claim 5, further comprising:
a temperature sensor located within the target manifold, said temperature sensor being electrically connected to said microcontroller.

7. A chilling system according to claim 6, further comprising:
a target heat sink connected to said target manifold, said target heat sink connecting to a target fan.

8. A chilling system according to claim 7, further comprising:
a target container, said target container receiving cooled air from said target fan.

9. A chilling system according to claim 8, further comprising:
a second temperature sensor located within said target container, said second temperature sensor being electrically connected to said microcontroller.

10. A chilling system according to claim 9, further comprising:
a third temperature sensor positioned outside of the target container for gauging the temperature of the environment outside of the system, said third temperature sensor being electrically connected to said microcontroller.

11. A chilling system according to claim 4, wherein:
the system is powered by direct current.

12. A chilling system according to claim 4, further comprising:
a reservoir fluidly connected to said pump.

13. A chilling system according to claim 10, wherein:
said microcontroller has an internal clock, said microcontroller determining and actuating a specific flow path based upon signal information, said signal information including signals received from said temperature sensor, from said second temperature sensor, from said third temperature sensor, from said first solid/liquid sensor and from said second solid/liquid sensor.

14. A chilling system according to claim 13, wherein:
said target container contains components to be protected from excess heat exposure.

15. A chilling system, comprising:
a pump;
a reservoir fluidly connected to said pump;
a first heat exchanger assembly that has a thermal electric cooler having a cool side and a hot side, with the cool side of said thermal electric cooler directly connecting to a cooling manifold, said cooling manifold receiving a propylene-glycol-water-mixture from said pump, and said hot side of said thermal electric cooler connecting to a first heat exchanger heat sink;
a first thermal transfer vessel, said first thermal transfer vessel being filled with a paraffin-based phase change material having a designated melting point temperature; said first thermal transfer vessel having first-transfer-vessel tubing through which said propylene-glycol-water-mixture enters and exits said first thermal transfer vessel;
a second thermal transfer vessel, said second thermal transfer vessel being filled with a second paraffin-based phase change material having a predetermined melting point temperature, said second thermal transfer vessel being fluidly connected to said first thermal transfer vessel and having second-transfer-vessel tubing through which said propylene-glycol-water-mixture enters and exits said second thermal transfer vessel;
a second heat exchanger assembly having second thermal electric cooler having a cool side and hot side, said cool side of said thermal electric cooler directly connecting to a second cooling manifold, said second cooling manifold receiving said propylene-glycol-water-mixture from said pump, and said hot side of said second thermal electric cooler connecting to a second heat exchanger heat sink;
a third thermal transfer vessel, said third thermal transfer vessel being filled with a third paraffin-based phase change material having a preselected melting point temperature; said third transfer vessel having third-transfer-vessel tubing through which said propylene-glycol-water-mixture enters and exits said third thermal transfer vessel;
a fourth thermal transfer vessel, said fourth transfer vessel being filled with a fourth paraffin-based phase change material having a set melting point temperature, said fourth thermal transfer vessel being fluidly connected to said third thermal transfer vessel and having fourth-transfer-vessel tubing through which said propylene-glycol-water-mixture enters and exits said fourth thermal transfer vessel;
a target container;
a target heat exchanger assembly fluidly connected to said first thermal transfer vessel, to said second thermal transfer vessel, to said third thermal transfer vessel and to said fourth thermal transfer vessel, said target heat exchanger assembly having a target-cooling manifold through which said propylene-glycol-water-mixture flows, said target heat exchanger assembly further including a heat sink connected to said target-cooling manifold, and said heat sink of said target heat exchanger assembly connecting to a fan that directs cooling air to said target container.

16. A chilling system, according to claim 15, further comprising:
a plurality of flow paths that can connect the cooling manifold, the first thermal transfer vessel, the second thermal transfer vessel, the second cooling manifold, the third thermal transfer manifold and the fourth thermal transfer vessel to the pump and to the target manifold and to the reservoir.

17. A chilling system, according to claim 16, further comprising:
a microcontroller;
a plurality of switches located in the plurality of flow paths, with said plurality of switches being opened and closed in response to signals sent from said microcontroller to effectuate a desired path through which the propylene-glycol-water-mixture can travel, said microcontroller being electrically connected to said plurality of switches.

18. A chilling system according to claim 17, further comprising:
a temperature sensor for sensing a temperature inside the target manifold, a second temperature sensor for sensing a temperature inside the target container, and a third temperature sensor positioned outside of the target container for gauging the temperature of the environment outside of the system, said temperature sensor, said second temperature sensor and said third temperature sensor being electrically connected to said microcontroller ;
a first solid/liquid sensor for detecting when the paraffin-based phase change material in the first thermal transfer vessel changes phase; a second solid/liquid sensor for detecting when said second phase change material changes phase; a third solid/liquid sensor for detecting when the third phase change material changes phase; and a fourth solid/liquid sensor for detecting when the fourth phase change material changes phase, said first, said second, said third and said fourth liquid solid sensors being electrically connected to said microcontroller.

19. A chilling system according to claim 18, wherein:
said microcontroller has an internal clock, said microcontroller determining and actuating said desired path based upon signal information, said signal information including signals received from said temperature sensor, from said second temperature sensor, from said third temperature sensor, from said first solid/liquid sensor, from said second solid/liquid sensor, from said third solid/liquid sensor and from said fourth solid/liquid sensor.
